(19) United States
(12) Patent Application Publication
(10) Pub. No.: US 2010/0275265 A1
(43) Pub. Date: Oct. 28, 2010

(54) System for securing transactions across insecure networks

(76) Inventors: Michael Stephen Fiske, San Francisco, CA (US); Martin Andres Quiroga, San Francisco, CA (US)

Correspondence Address: Michael Fiske, P.O. Box 475178, San Francisco, CA, 94147, US

(21) Appl. No.: 12/661,763

(22) Filed: Mar. 24, 2010

Related U.S. Application Data
(60) Provisional application No. 61/214,651, filed on Apr. 27, 2009.

(51) Int. Cl. G06F 21/00

(52) U.S. Cl. 726/26; 726/5

(57) ABSTRACT

A new system is presented here that can effectively protect users' identities, their sensitive data and help secure transactions. The security of this system does not depend on the integrity of the host personal computer nor on the security of the network computers that execute network traffic. Furthermore, the system is designed to help prevent identity theft. This system can be implemented for governments, financial exchanges and health care systems where security is a primary concern.

### RELATED APPLICATIONS

This application claims priority benefit of U.S. Provisional Patent Application Ser. No. 61/214,651, entitled “Ten Requirements for securing transactions across an insecure Internet,” filed Apr. 27, 2009, which is incorporated herein by reference.

### FIELD

The specification generally relates to security and transactions.

### BRIEF DESCRIPTION OF THE FIGURES

In the following figure(s), although they may depict various examples of the invention, the invention is not limited to the examples depicted in the figures.

FIG. 1 shows computers acting as host domain(s) and groups of computers acting as a network domain.

### DETAILED DESCRIPTION

Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

Fraud, identity theft and data theft are rampant and continue to increase at alarming rates in spite of the enormous amounts of technology and resources that institutions and governments devote to combating these crimes. Moreover, it is clear from the wide-scale damage inflicted by recent worms, such as Conficker, that existing state of the art identity protection and management (IPM) systems fall short of containing or minimizing the spread of successful cyber attacks used for committing these crimes.

The core of the problem lies in the shortcomings of vulnerability assessment and remediation procedures. First known vulnerabilities must be detected (i.e. an un-patched web server) and subsequently patches for the affected operating systems or applications must be applied as updates. These procedures that are common in the prior art are tedious and can often affect operational continuity, which means they are often delayed or altogether neglected.

Further aggravating this problem is the highly-mobile nature of today's workforce, and their dependence on a portable PC. This significantly complicates the logistics of administration and management of the portable PC, which are often connected in highly hostile and unprotected environments, such as airports or coffee shops. Thus the critical tasks of vulnerability assessment and remediation are left to end-users—arguably the least equipped individuals to deal with such endeavors. Hence, systems implemented with prior art methods have created a “perfect storm” environment for wide-scale attacks, such as worms.

It was recently discovered that the U.S. electrical grid had been compromised by spyware, possibly planted by Chinese or Russian hackers [1]. The level of sophistication involved in this incident as well as in software code such as Conficker and other malware suggests that well-financed organizations and governments are sponsoring these developments.

Present-day estimates of the economic impact of cyber crime topples a staggering 1 trillion US dollars per year [2]. Significantly contributing to this monetary figure are preventable attacks that leverage previously obtained information such as static login tokens, credit card verification parameters and cryptographic keys. Clearly, current technology and best-practices of the prior art cannot keep up with the rate of spread or the efficacy of modern-day attacks.

A new system is presented here that can effectively protect users' identities and their sensitive data. This solution does not depend on the integrity of the host PC which is notoriously insecure, often un-remediated and clearly the most significant vector for the spread of wide-scale attacks.

Ten requirements are presented that, if complied with properly, effectively protect against some of the most common and devastating forms of cyber attack. First, these requirements are explained along with some embodiments, followed by a discussion of how these address the following types of attack families:

A. Spoofing

B. I/O Sniffers

C. Stack/Runtime Analysis

This Confidentiality Identity and Authentication Protocol is a novel system for protecting individuals, their online identities, data and transactions. It is the first implementation of these requirements.

A system's security assurance capabilities must be considered not only on the merits of its independent properties, such as cryptographic methods and protocols, but also in terms of its operational structure. Some of the prior art security practices follow standards and definitions that are not understood systemically and often times, system implementations leave large, unattended gaps and weaknesses. An example of this is the common implementation of online authentication systems that “leak” authorization information by providing different response behavior (content and/or timing) to bad username or password inputs—thus opening the door to side-channel attacks. Beyond treating security assurance from a systems perspective, data must also be understood in terms of its security value and protective resources allocated accordingly. For example, there is a significant difference between data contained in a communication channel containing unencrypted web traffic from a public news site, versus a channel carrying encrypted web content from a user's online banking site. A comprehensive solution must facilitate switching between sensitive and non-sensitive data contexts, while maintaining an impenetrable boundary between the two.

The ten requirements presented here represent a systematic approach for treating all sensitive data exchanges as secure transactions and also presents the system properties to secure these transactions and exchanges. While contemporary operating systems and applications will continue to be susceptible to the ever-evolving slew of cyber attacks, a system following these requirements can still effectively protect a user's identity, their selected data, and their transactions so that if a system is compromised, damage will be contained and a user's credentials or data will not be accessible for leverage in subsequent attacks.

A secure transaction is defined as an atomic operation that is assured of availability, confidentiality, integrity, authenticity, authority and accountability. To this end, the following requirements should be met by a secure transactional system operating across an insecure Internet:

I. Any operation(s) that must run in a trusted environment shall be treated as a secure transaction.
II. A secure transactional system shall assume that the host and network domains are untrusted.
III. A new notion of a User Domain shall be implemented as a secure module with a minimal degree of programmability.
IV. The User Domain shall be maximally integrable with the Host and Network Domains.
V. A Security Operational Stack shall be maintained and information from a higher layer shall never leak to a lower one.
VI. Authentication operations shall be decentralized, while authorization operations shall be centralized.
VII. Every authorization operation shall be coupled with an authentication operation.
VIII. No pins or passwords shall be stored anywhere on the system.
IX. Multi-modal biometric authentication shall be seamlessly integrated with cryptographic operations.
X. Static tokens shall only be entered into the secure user module, while dynamic tokens shall be used for all necessary external operations.

I. Any operation(s) that must run in a trusted environment shall be treated as a secure transaction. The field of computer science defines a transaction as an individual or indivisible set of operations that must succeed or fail atomically (i.e. as a complete unit that cannot remain in an intermediate state). Operations that carry out availability, confidentiality, integrity, authenticity, authority and/or accountability should be executed in a trusted environment: these types of operations shall be treated as a secure transaction. Further, a successful transaction alters a system from one known, good state to another, while a failed transaction does not (save for logging). To achieve this stateful functionality—particularly in systems that handle concurrent transactions—rollback, rollforward and deadlock handling mechanisms must be employed to assure atomicity and system state integrity.

The notion of a secure transactional system must assure the following properties:

A. Availability: Having timely and reliable access to a transactional resource.

B. Confidentiality: Ensuring that transactional information is accessible only to those authorized to use it.

C. Integrity: Ensuring that transactional information is protected from unauthorized modification.

D. Authentication: Ensuring that transactional resources and users accessing these are correctly labeled (identified).

E. Authorization: Ensuring users access rights to transactional resources.

F. Accounting: Ensuring that a transaction cannot be repudiated. Any operation that handles or provides access to data deemed too sensitive for an untrusted environment (i.e. any private data) must be treated as a secure transaction to ensure that information leakage does not occur.

Any operation that handles or provides access to data that is deemed too sensitive for an untrusted environment (i.e. any private data) must be treated as a secure transaction to ensure that information leakage does not occur.

II. A secure transactional system shall assume that the host and network domains are equally untrusted.

A computational device is defined as a collection of hardware, and in some embodiments additional firmware and/or software, that receives digital or analog inputs through a user or network interface, processes logical instructions on the inputs (in a self-contained manner) and outputs the results of the operations though another user interface—for example, a computer screen. In some embodiments, computational devices are communicatively-coupled to other computational devices. In some embodiments, a communicatively-coupled, computational device contains logic, stored in memory, to perform the functions of the Host Domain defined next.

The host domain refers to the computing environment executing in the personal computer, mobile phone or other device that the user physically interacts with to access resources. “Physically interacts” means the user may type in a password into the keyboard of the “host domain” computer or even place his or her finger on a sensor connected directly to the “host domain” computer. The host domain renders the user interface to the secure application being accessed. In other embodiments, the host domain may refer to a mobile phone containing a processor that is executing an operating system that supports a web browser.

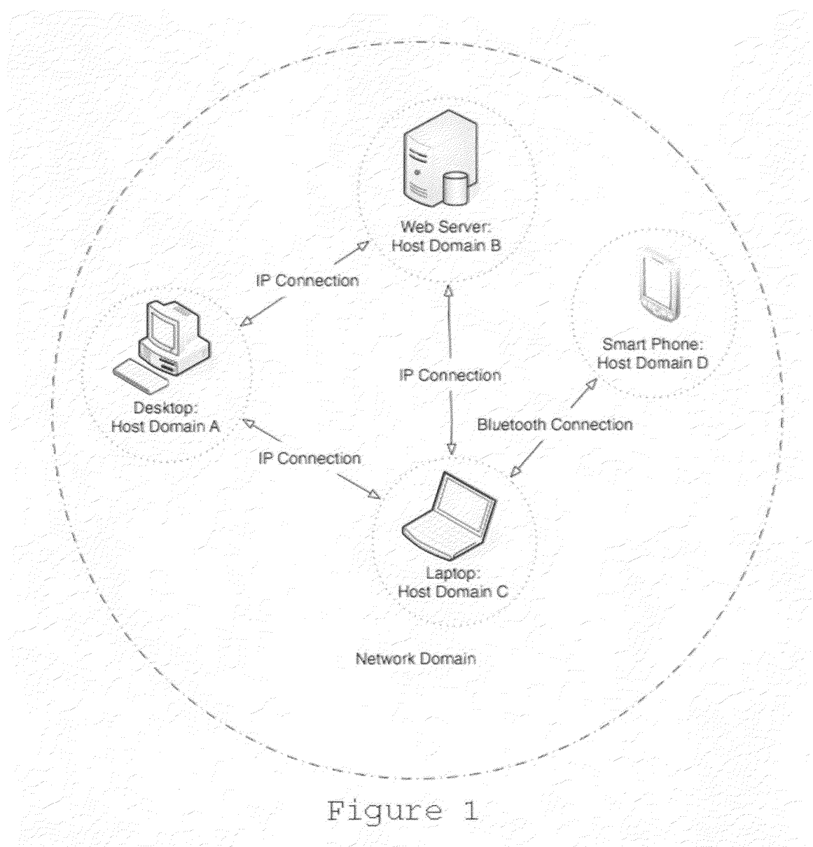

A computational device may perform ‘routing operations’, passing signals between other computational devices. The network domain refers to the communication infrastructure—comprised of computational devices, as well as physical and virtual media—that enables the transmission and routing of signals between distinct computational devices. In one embodiment, the network domain may refer to the interconnected, Internet Protocol (I.P.) networks that comprise the Internet. In another embodiment, the network domain may refer to a bluetooth connection between a user's mobile phone and their wireless headset. The network domain is comprised of host domains and network communications between these host domains. FIG. 1 shows some computational devices acting as host domain devices and others as network domain devices.

In the prior art's methods of designing secrecy systems, there has been a distinction between two domains—trusted and untrusted. The trusted domain processes and encrypts information for subsequent transmission through an untrusted medium or channel. The objective of secrecy systems is to maintain a well-defined impermeable boundary between these two domains. With the invention of the Internet this boundary has become unclear and security breaches resulting in data loss and compromise have increased dramatically over time.

The Internet from its inception was optimized for intercommunication and interoperability, and security assurance is still largely seen as a problem at the application layer (in the OSI model). Modern-day operating systems contain some mechanism(s) to distinguish between trusted and untrusted domains, which in the Internet model are the host and network domains, respectively. Implementations of this mechanism are most often protected by the use of static tokens and are host-based, which assume that the host is trusted (i.e. entering a fob-generated OTP into an unverified browser).

Computer worms and an ever-increasing amount of operating system and application vulnerabilities too often result in successful breaches of this critical boundary and significant subsequent data and operational losses. For this reason, an effective transactional assurance mechanism must assume that the host domain is untrusted, along with the network domain.

III. A new notion of a User Domain shall be implemented as a secure module with a minimal degree of programmability. The user domain is functionally distinct from the host domain and the network domain. The user domain is implemented as a secure module, an operationally-independent, communicatively-coupled, restricted computing environment with the following properties and mechanisms:
A. A minimal degree of programmability.
B. Minimally-accessible and error checked communication exchanges.
C. All communication exchanges are executed as secure transactions.
D. Static authentication factors are entered only into the secure module interface.
E. No static authentication factors ever leave the secure module, even if encrypted.
F. Physical tampering or breaching of secure module will wipe all plaintext secret and private keys, any other critical security parameters (CSP's) and operational instruction set—i.e. compliant with FIPS 140-2 Level 3[3].

In some embodiments, properties and mechanisms A. through F. may be implemented in embedded code that executes on a processor chip that is not executing an operating system. In some embodiments, the embedded code may execute in an ASIC. In other embodiments, the embedded code may execute in an FPGA chip that can only be programmed once. In some embodiments, the embedded code may be encrypted. In some embodiments, there may be physical barriers around the chip that executes the embedded code.

In mobile device (phone, laptop or other mobile product) embodiments, there may be one processor chip that executes an operating system that provides host domain functionality and a distinct processor chip that executes only embedded code that provides the secure module functionality. In other mobile device embodiments, the secure module may execute on the same chip that executes the host domain functionality but it is preferable for the host domain to not be able to directly access the secure module. If the host domain has direct access to the secure module, this blurs the boundary between the trusted environment (secure module or User domain) and the untrusted environment (Host domain) and may create security vulnerabilities.

The notion of a minimal degree of programmability can be further defined as a computing environment with these two properties:
A. A finite, immutable, operationally-restricted instruction set—i.e. no OS or application that can be updated.
B. An encrypted and restricted data set.

IV. The User Domain shall be maximally interoperable with the existing Host and Network Domains. With the user domain being implemented as a secure module, maximum interoperability with the host and network domain is essential. The host and network domains represent a very large variety of network infrastructure, operating systems and applications. For this reason, the communication coupling must be based on cross-platform standards. This includes USB, Bluetooth and Near Field Communications (NFC). Also, the secure module should integrate, where it is deemed appropriate, integrate with existing secure solutions such as VPN and PKI systems. Additionally, all secure module operations should be self-contained and any application on the host domain (PC) only routes encrypted transactions transmitted from the secure module.

V. A Security Operational Stack shall be maintained and information from a higher layer shall never leak to a lower one. A securely-implemented transactional system must fulfill the following functions:
A. Availability
B. Confidentiality
C. Integrity
D. Authentication
E. Authorization
F. Accounting

The operational stack order represents that Availability has a higher priority over all other functionalities in the stack. As an example, a denial of service attack would knock out Availability so that all other functions would become irrelevant in accessing that resource. Confidentiality has the second highest priority. The operational stack is complementary and backward compatible with current implementations of these functions. In some embodiments, the confidentiality, integrity and authentication stack operations are compatible with NSA Suite B cryptography. In some embodiments, Confidentiality can be implemented using Elliptic Curve Diffie-Hellman [4] to complete the key exchange and using AES-256, FIPS 197 [5] to perform the encryption of the message or data. In some embodiments, Authentication can be implemented with Elliptic Curve Digital Signature Algorithm, FIPS 186-2c [6]. In some embodiments, Integrity can be implemented with Secure Hash Algorithm—FIPS 180-2, using SHA-512 [7].

VI. Authentication operations shall be decentralized, while authorization operations shall be centralized. In embodiments that implement a secure transaction system, compromising one node should never compromise the rest of the system. Some current biometric systems are implemented so that they violate some of the requirements; as a result there are security vulnerabilities in the prior art implementations.

Namely in the prior art, the biometric data or prints are stored on the backend, typically in a database. In this scenario, a backend compromise would result in massive identity theft. Additionally, since biometrics are immutable, any significant breach—say a database with biometric data for a million users—would essentially make biometrics useless as an authentication factor for those users. For this reason, biometric data should not be stored on a backend server or database.

According to requirement VI., in embodiments, user credentials should be decentralized on a secure module. Further, dynamic tokens should be sent to the backend server. Thus, a break-in of the system would not compromise any biometric data and helps protect a user's identity. In these embodiments, backend break-ins would only compromise user identifiers and big numbers. With a breach of this information, the system can be easily reset. Authorization, on the other hand, should be centralized so that user access to system resources can be administered from an aggregate control point. For example, locking out a disgruntled employee is a procedure that would not involve the user and would be carried out by an authorized system administrator.

VII. Every authorization operation shall be cryptographically coupled with an authentication operation. In the prior art, there are two main authorization system paradigms that are utilized in current transactional systems: the Access Control List (ACL) approach and the capability-based authorization approach.

One common method in the prior art is the ACL approach, which is implemented as a list with permission/user relationships, with which accessor processes verify that actions being carried out by the process owner are permitted. For example, in the case of the Unix file system (UFS), the “permissions list” is implemented as numbered inodes containing file metadata including ownership and permissions. A common problem with ACL implementations is that the list only contains a reference to the user's identity which results in common, well-known vulnerabilities (i.e. Privilege Escalation, Confused Deputy, etc).

Capability-based authorization systems require that the accessor process possess a token of authority (i.e. the capability) in order to carry out a requested action on a particular resource. Although these systems offer higher level of assurance than ACL-based systems, they depend on capability sharing amongst users, which essentially amounts to shared tokens—an approach susceptible to all static token attacks (i.e. Sniffing, Spoofing, etc).

With the introduction of a user domain-based, secure dynamic tokens can be used to authorize resource rights, while simultaneously authenticating a user's identity with each authorization operation.

VIII. No pins or passwords shall be stored anywhere on the Host or Network Domains. This prevents PIN-hacking attacks and cumbersome cryptographic protocols and methods needed to secure the PINs and passwords on the system. In addition, this method eliminates protection and maintenance of passwords and PINs on the system. In addition to keeping PINs and passwords off the untrusted host and network domains, an ideal system would use mathematical techniques so that cryptographic keys, passwords and PINs are not stored on the secure user module. If a foreign adversary with sophisticated technical resources were to capture the secure module in the field, they would not be able to read or reconstruct the keys, PINs or passwords even with advanced methods such as UV reading of memory. PIN and password security should also be resistant to reverse engineering attacks.

IX. Multi-modal biometric authentication shall be seamlessly integrated with cryptographic operations. In standard Identity Management systems, there is an on/off authentication switch between a biometric authentication and the release of cryptographic keys in applications using cryptographic protocols. This leaves a vulnerability (seam) between the biometric authentication and the cryptographic operations. As an alternative, this system performs all cryptographic operations on a secure module

where the biometric authentication occurs. The lack of an operating system on the secure module reduces the degrees of programmability, greatly diminishing security breaches and attacks between the biometric authentication and the cryptographic operations required in the user domain.

X. Static tokens shall only be entered into the secure user module, while dynamic tokens shall be used for all necessary external operations. Static tokens are PINs, passwords, biometric data and other user information. They are user friendly because they are static but they are also susceptible to replay attacks. For this reason, they must entered directly into a secure user module. This prevents key logging and other types of malware capturing these static tokens.

Dynamic tokens help prevent key logging, sniffing, resubmission attacks, and replay attacks. The dynamic tokens should be implemented with non-autonomous dynamical systems [8] and NSA-approved cryptography. This increases the entropy and Kolmogorov complexity (unpredictability) of an ideal system. Advanced methods in dynamical systems can be used to predict the behavior of complex systems such as cryptographic algorithms and other important algorithms in a security system. These methods have been shown to build highly effective predictive models of complex systems when standard statistical methods only indicate that the behavior of the complex system is coming from an assumed Gaussian source [9]. The generation of dynamic tokens must be designed with these advanced and possibly unforeseen attacks in mind.

Addressing Attacks. In this section we look at the efficacy of the ten requirements relative to three common types of attack families: Spoofing, I/O Sniffers and Runtime Analysis. Attack Family Spoofing. Common Forms: Phishing, DNS cache poisoning, man-in-the-middle and cross-site scripting (XSS). Description: Spoofing attacks take advantage of surmountable authentication mechanisms, where a malicious user, process or resource masquerades as a valid one, thereby gaining an illegitimate advantage. In many of these attacks the primary objective is to obtain user credentials that can be later used for unauthorized activity. In the case of cross-site scripting attacks, it was estimated that nearly 70% of websites in 2007 were open to these attacks [10]. In terms of monetary loss, also in that same year phishing attacks affected 3.6 million adults, at a loss of US $3.2 billion [11].

Counter-measure: There are two primary mechanisms by which spoofing attacks are addressed by the ten requirements. First is leveraging the secure module nature of the solution, which stores the necessary PKI certificates, OTP seeds and any other user credentials that should not stored on the host PC (where they could be altered). This approach can leverage existing authentication mechanisms, but in a far more secure configuration—providing a trusted mechanism for essential two-way authentication. Also, particularly for phishing attacks, using a secure module that accepts a fingerprint and can verify for the user the authenticity of a secure site, removes the human element of having to assess whether a site is a legitimate place to enter user credentials.

The second mechanism is the use of One-time Passcodes, for every authorization operation, which as mentioned above would also be cryptographically coupled with an authentication operation as well. This approach would secure against common cross-site scripting attacks that leverage previously gathered user data (i.e. a web browser cookie).

Attack Family: Input/Output (I/O) Sniffers. Common Forms: Network sniffers (i.e. tcpdump, ethereal), keystroke loggers and RF capture. Description: Security attacks categorized as I/O sniffers present a significant risk because they aim to capture input and output streams from host PC processes that contains sensitive data to be used in later attacks. This includes passwords, PINs, biometric prints or templates and any other user data that must remain private.

Counter-measure: Since all static authentication tokens are entered directly into the secure module interface, this prevents key stroke loggers and other malware from capturing these authentication tokens. Additionally, the minimal degree of programmability that prevents new code from executing in the secure module assures that I/O sniffers can not be installed. Moreover, because one-time passcode authentication factors may only be used once, these dynamic tokens thwart the I/O sniffers executing in the untrusted host and network domains. Catch and resubmit attacks that may be added to an I/O sniffer are thwarted because only the secure module has access to its private certificate, which signs the transaction along with the one-time passcode.

Attack Family: Runtime Analysis.

Common Forms: debuggers (i.e. gdb), disassemblers (i.e. IDA Pro, OllyDgb) and emulators
Description: Runtime analysis attacks are perhaps some of the most sophisticated attacks, which are comprised of observing a running process and capturing the executing instruction set and data contained within through the use of specialized software. These attacks are very difficult to prevent if an attacker has access to an operating environment which is running a critical process that may contain or route critical data such as keys, certificates or any other sensitive information. The prior art does not have adequate methods of addressing these attacks.

Counter-measure: Since critical transactional functions run on a secure module with a minimal degree of programmability, runtime analysis cannot occur in that environment itself. Additionally, in some embodiments tampering with the physical device—that carries out the secure module functionality—to attempt to extract the instruction set for execution on an emulator results in destruction of the data set.

### REFERENCES

[1] http://online.wsj.com/article/SB123914805204099085.html
[2] http://tech.yahoo.com/blogs/null/120939
[3] http://csrc.nist.gov/publications/fips/fips140-2/fips1402.pdf
[4] http://csrc.nist.gov/groups/ST/toolkit/documents/SP800-56Arev1_{—}3-8-07.pdf
[5] http://csrc.nist.gov/publications/fips/fips197/fips-197.pdf
[6] http://csrc.nist.gov/publications/fips/fips186-3/fips_{—}186-3.pdf
[7] http://csrc.nist.gov/publications/fips/fips180-2/fips180-2withchangenotice.pdf
[8] http://www.google.com/patents/about?id=6-d_AAAAEBAJ&du=NADO+cryptography
[9] http://www.edge.org/q2006/q06_{—}11.html#kosko
[10] http://www.csoonline.com/article/221113/Software_Vulnerability_Disclosure_The_Chilling_Effect
[11] http://www.gartner.com/it/page.jsp?id=565125

1. A transaction system comprising operations that support confidentiality, integrity and authenticity.

2. The system of claim 1 wherein said operations are executed in a trusted environment.

3. The system of claim 2 wherein said trusted environment is executed with embedded code.

4. The system of claim 2 wherein said operations are not executed in the host domain.

5. The system of claim 2 wherein said operations are not executed in the network domain.

6. The system of claim 2 wherein trusted environment is implemented as a secure module.

7. The system of claim 6 wherein no static authentication factors leave the secure module.

8. The system of claim 6 wherein static authentication factors are only entered through the secure module interface.

9. The system of claim 6 wherein the secure module contains a biometric sensor.

10. The system of claim 8 wherein said authentication factor is a fingerprint.

11. The system of claim 8 wherein said authentication factor is a PIN or password.

12. The system of claim 6 wherein said secure module executes a restricted instruction set.

13. The system of claim 6 wherein said secure module does not execute an operating system or application that can be updated.

14. The system of claim 6 wherein no user information is stored in any form outside the secure module.

15. The system of claim 14 where said user information is one or more biometric prints or templates.

16. The system of claim 14 where said user information is a PIN or password.

17. The system of claim 6 wherein dynamic tokens may leave the secure module.

18. The system of claim 15 wherein said dynamic token is a one-time passcode.

19. The system of claim 2 wherein some said operations carry out authorization that is cryptographically coupled to authentication.

20. The system of claim 2 wherein some said operations carry out accounting that is coupled to authentication.
